(19) United States
(12) Patent Application Publication
(10) Pub. No.: US 2026/0369147 A1
(43) Pub. Date: Nov. 19, 2026

(54) Apparatus for Detecting Smoke/CO2 and Location

(71) Applicant: Lawrene Anne Raggio, Sewell, NJ (US)

(72) Inventor: Lawrene Anne Raggio, Sewell, NJ (US)

(21) Appl. No.: 19/278,955

(22) Filed: Jul. 24, 2025

Related U.S. Application Data
(60) Provisional application No. 63/676,340, filed on Jul. 27, 2024.

(51) Int. Cl. G08B 17/10; G01S 19/17; G08B 25/00

(52) U.S. Cl. CPC G08B 17/10; G01S 19/17; G08B 25/006

(57) ABSTRACT

This portable, multi-functional safety device detects environmental hazards and enables personal tracking and emergency alerts. It combines a smoke detector, CO₂ sensor, GPS locator, wireless communication module, and two-way camera in a compact housing. Using wireless solar charging with microwave power transmission, the device operates for extended periods without relying on a standard power source. It connects to local Emergency Broadcast Systems to receive and transmit severe weather and emergency alerts to paired devices, providing real-time updates. The device continuously analyzes environmental conditions, transmits location and hazard data, and alerts users through visual, audio, and wireless notifications. The invention enhances user safety by detecting hazards, environmental monitoring, geolocation tracking, and emergency communication in a single system. It offers a layered approach to personal and environmental safety monitoring for proactive emergency preparedness.

### BACKGROUND OF THE INVENTION

Conventional portable safety devices typically address a single hazard or functionality, such as smoke detection or GPS tracking, and often require manual operation, frequent charging, or constant connection to traditional power sources to remain functional. Many existing smoke detectors are stationary and rely on the building's infrastructure, while personal safety devices often lack integrated environmental monitoring or seamless emergency alert capabilities.

Current emergency alert systems often fail to provide real-time, location-specific data transmission, combined with environmental hazard detection, in a portable form, thereby limiting situational awareness for individuals during fire, environmental hazards, or severe weather events.

The increasing need for layered personal safety monitoring, especially in environments where individuals may be mobile, in transit, or areas prone to environmental hazards, there is a need for a compact, multi-functional device capable of monitoring environmental conditions, providing geolocation data, enabling two-way communication, and receiving and transmitting emergency alerts in real time, while maintaining continuous operational readiness through advanced power solutions.

The present invention addresses these limitations by providing a portable, integrated system that combines smoke and CO2 detection, GPS tracking, two-way communication, and wireless connectivity with a wireless solar charging system, integrated into a single, compact device capable of connecting to local Emergency Broadcast Systems for real-time alerts and layered situational awareness.

### SUMMARY OF THE INVENTION

The invention is a portable, multi-functional safety and environmental monitoring device that integrates smoke detection, carbon dioxide (CO₂) sensing, GPS tracking, two-way camera communication, and wireless connectivity within a compact housing designed for ease of transport and deployment.

The invention automatically detects environmental hazards, such as the presence of smoke or elevated CO₂ levels. It transmits real-time alerts and geolocation data to paired devices, enhancing personal safety during emergencies. The integrated two-way camera system enables live audio and video communication between the user and a monitoring device or emergency responders, supporting verification and situational awareness.

The device connects to local Emergency Broadcast Systems (EBS), receiving and relaying severe weather and hazard alerts to the user. Its visual and audio notification system ensures immediate local awareness of detected hazards.

To maintain continuous operational readiness, the invention incorporates a wireless solar charging system utilizing photovoltaic cells and microwave power reception, reducing reliance on traditional power sources and ensuring extended operation during emergency scenarios.

The invention enables layered safety monitoring and communication capabilities, addressing the limitations of conventional safety devices by providing a comprehensive, portable, and real-time environmental monitoring and alert system for individuals, vehicles, and outdoor or emergency environments.

### TECHNICAL FIELD OF THE INVENTION

The invention relates to the fields of fire detection, environmental hazard detection, personal safety monitoring, and emergency alert systems, particularly to portable devices that integrate smoke detection, gas detection, GPS tracking, two-way communication, and wireless power systems within a compact form factor for use in personal, vehicular, and outdoor applications.

### DETAILED DESCRIPTION OF THE INVENTION

In FIG. 1, the invention shown is a compact, portable, multi-functional safety monitoring and personal tracking device designed to detect environmental hazards. The device combines the safety features of a smoke detector (FIG. 110) and a CO₂ detector (FIG. 112), providing an added layer of protection through the inclusion of a GPS (FIG. 116) and a two-way camera system (FIG. 114) in a portable, compact housing. The system's multifunctionality provides an added layer of safety and security in the event of environmental hazards. The device is lightweight and built with a durable casing. The features are housed in a waterproof, rounded body equipped with a clip, hook, and adhesive backing, providing both portability and a permanent fixture in the home. The user interface features a single, multifunctional alert button with small LED status indicators (FIG. 120) that display power, connectivity, hazard alerts, and vibration mode for silent notifications.

Integrated sensors combine both smoke detector and carbon monoxide (CO₂) miniature sensors (FIG. 110, FIG. 112). The smoke and CO₂ sensors detect environmental particulates and monitor CO₂ concentration levels. The two-way camera (FIG. 114) enables real-time video capture and transmission by supporting both manual activation and automatic activation during emergencies. The device is equipped with a speaker and microphone (FIG. 122), enabling two-way communication during emergencies. The GPS locator (FIG. 116) provides accurate, real-time location tracking, enabling emergency responders to locate the user. The wireless communication module (FIG. 118) supports Bluetooth, Wi-Fi, and 5G/LTE connectivity when paired with smartphones and computers. This enables the direct transmission of emergency data to monitor centers.

In FIG. 2, the device features three power modes: a solar charging system, a rechargeable standby battery, and microwave power transmission capability (FIG. 124). Flexible solar panels (FIG. 126) are integrated into the exterior housing for supplemental charging, extending operational time in outdoor conditions. The rechargeable, standby battery (FIG. 128) is comprised of a rechargeable lithium-polymer battery capable of providing up to 7 days of standby operation, with low-battery alerts sent to paired devices. The microwave power transmission (FIG. 130) supports wireless charging using microwave energy transfer, enabling continuous operation in specific environments. This can also be an optional feature for any type of institutional application.

The device is also configured to connect and be integrated with the local Emergency Broadcast System (EBS) for real-time alerts during severe weather (tornadoes, hurricanes, flash floods, power outages, etc.). It can also broadcast active shooter situations and other emergencies. The device will send automatic alerts to pre-designated contacts (added via computer or mobile application) or emergency services when environmental hazards are detected. This will include both location and environmental data.

Operational features of the device include a user-activated manual emergency trigger button. The SOS button sends location, live camera feed, and environmental sensor data to emergency contacts. The device provides automatic alerts when smoke, high CO₂ levels, or rapid temperature increases are detected, triggering automatic notifications. Additionally, the device can be activated to create a geofence and send alerts if the user moves out of a designated safety zone, which can be useful for monitoring children, hikers, or elderly individuals. The device's tracking capabilities provide an activity log that records environmental readings, user movement, and alert history, accessible through the paired mobile application for both safety tracking and health monitoring.

The mobile application integration within the system provides real-time location tracking, notifications for environmental alerts, access to live video/audio feeds during emergencies, historical data analysis for safety monitoring, geofence configuration and alert customization, and device status monitoring (including battery level and connectivity).

### BRIEF DESCRIPTION OF DRAWINGS (FIGS. 1,2,3,4)

FIG. 110 is a smoke detector
FIG. 112 is a CO₂ detector
FIG. 114 is a two-way camera system
FIG. 116 is a GPS
FIG. 118 is a wireless communication module
FIG. 120 is a multifunctional alert button with small LED status indicators
FIG. 122 is a speaker and microphone
FIG. 124 is a three-power mode: a solar charging system, a rechargeable standby battery, and microwave power transmission capability
FIG. 126 is a flexible solar panel
FIG. 128 is a rechargeable, standby battery
FIG. 130 is a microwave power transmission

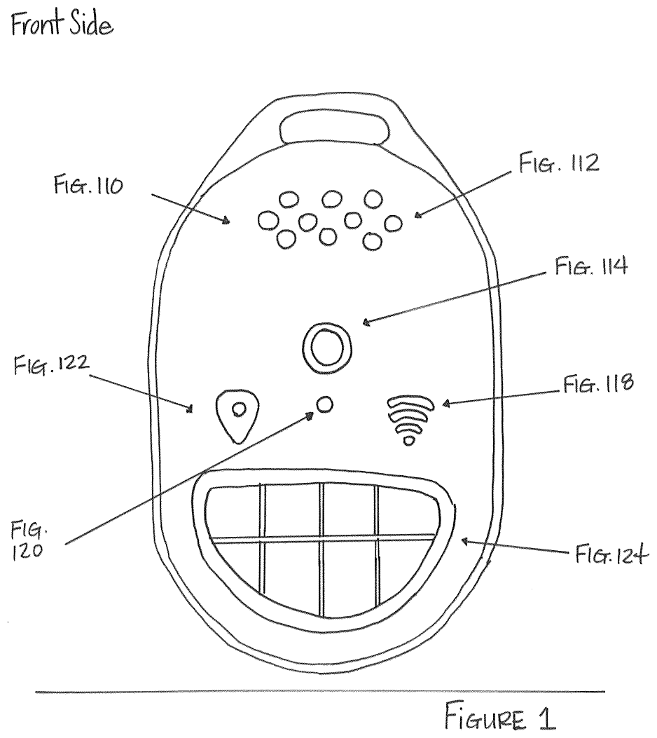

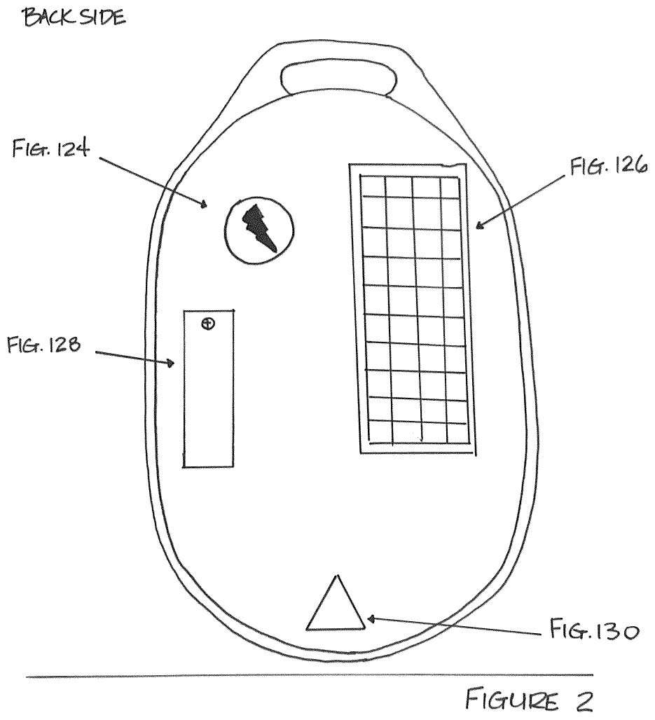

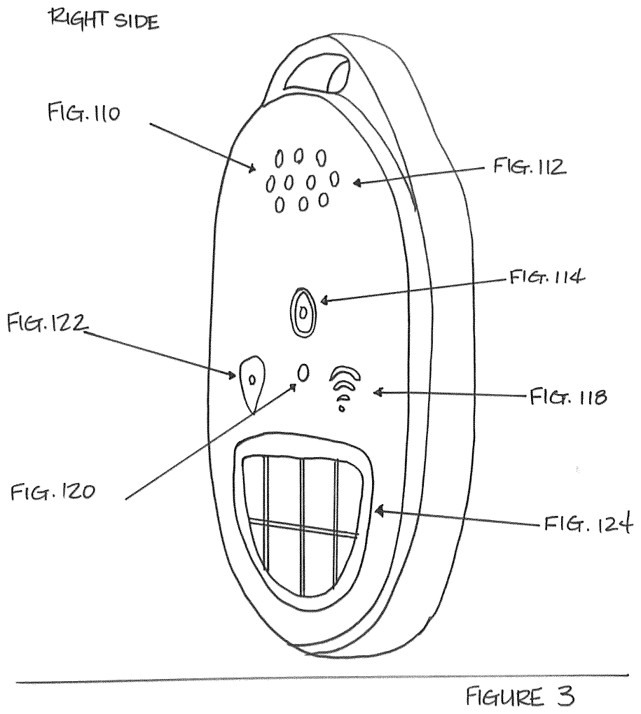

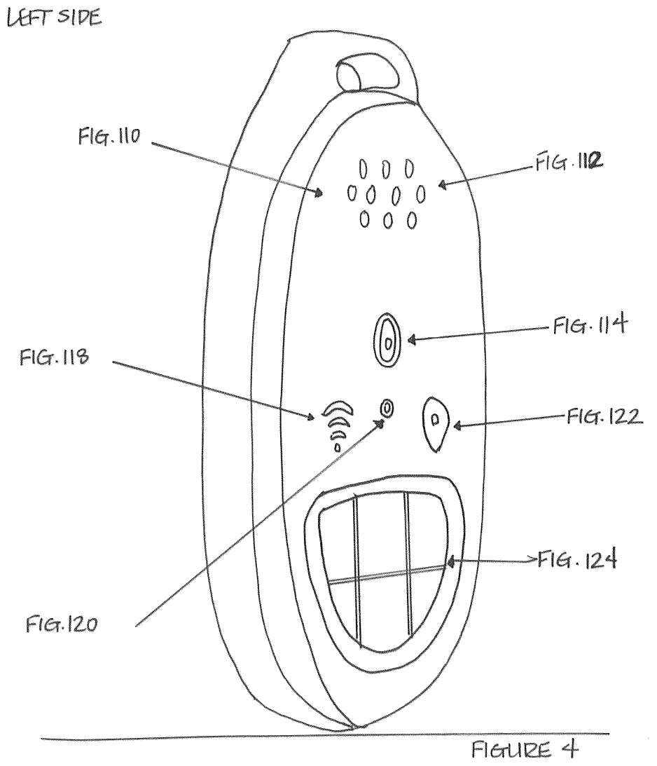

1. A portable, multi-functional safety monitoring device wherein the microcontroller is configured to generate alerts based on detected smoke, CO₂ levels, or environmental hazard thresholds. A smoke detection module is positioned along with a carbon dioxide (CO2) sensor. The smoke detector module identifies the presence of particulates in the air, indicating the potential for combustion or fire. The CO₂ sensor detects increased carbon dioxide levels. The placement of both modules adjacent to one another provides cross-validation, wherein it reduces false alarms from non-fire particulates, such as dust and steam, while confirming combustion through CO₂ detection.

2. The device of claim 1, wherein the wireless communication module located within the device has Wi-Fi and/or cellular connectivity and capability. The hardware components within the device include a micro-Wi-Fi chip, which enables connectivity to wireless networks for data transmission and firmware updates. The cellular module consists of a 5 G-capable modem to allow connection to cellular networks when Wi-Fi is unavailable, wherein ensuring connectivity during power outages or emergencies.

3. The device of claim 1, wherein has a GPS locator wherein the user can manually activate the locator in the event of an emergency, sending the user's current location to paired devices or emergency services to request assistance. The GPS locator provides severe weather or hazard alerts by providing data to the user, informing evacuation decisions or confirming the user's location relative to the hazards. The GPS locator can track the device's movement during use in personal vehicular or outdoor settings to assist in safety monitoring.

4. The device in claim 1, wherein further comprises a two-way camera system for live video and audio communication, wherein the user and emergency services can communicate during an alert. The two-way camera system allows responders to see and hear the user's environment in real time, verify conditions, provide immediate guidance, and improve safety during emergencies wherein offering reassurance and situational awareness to both the user and responders.

5. The device of claim 1, wherein a wireless solar charging system with a photovoltaic cell array and microwave power transmission for power supplementation is housed, is provided. Wireless charging replaces conventional power sources, making it a more portable option.

6. The device of claim 1, wherein the system is configured to connect to local Emergency Broadcast Systems (EBS) to receive and transmit severe weather and emergency alerts, providing real-time updates to the user. The invention features a microcontroller that receives, processes, and transmits environmental and location data through visual, audio, and wireless notifications, alerting the user based on environmental hazard thresholds. The portable device interface can pair with a computer or mobile device to receive real-time alerts and track location.

7. The device of claim 1 wherein further comprises a housing configured for wearable use, vehicle attachment, or affixation to personal belongings, and including an integrated audio and visual notification system for local user alerts during detected hazards, wherein providing a layered approach to environmental and personal safety monitoring.
